(19) United States
(12) Patent Application Publication
(10) Pub. No.: US 2008/0223705 A1
(43) Pub. Date: Sep. 18, 2008

(54) Touch-sensing device and sensing method for electrical apparatus

(75) Inventors: Ching-Sung Chang, Taipei County (TW); David Ho, Shanghai City (TW); Wei Shen, Shanghai City (TW)

Correspondence Address: REED SMITH LLP, Suite 1400, 3110 Fairview Park Drive, Falls Church, VA, 22042, US

(73) Assignee: Inventec Appliances Corp.

(21) Appl. No.: 11/812,643

(22) Filed: Jun. 20, 2007

(30) Foreign Application Priority Data
Mar. 16, 2007 (TW) 096109049

(51) Int. Cl. H01H 13/70

(52) U.S. Cl. 200/5 A

(57) ABSTRACT

The invention discloses a touch-sensing device for an electrical apparatus. The touch-sensing device, according to the invention, includes a sensing panel, a detector, and a controller. The sensing panel includes an inner sensing region and an outer sensing region. The inner sensing region, disposed on the sensing panel, is substantially divided into a plurality of equivalent inner sensing sub-regions. The outer sensing region, disposed on the sensing panel, is at the outer edge of the inner sensing region. The outer sensing region is substantially divided into a plurality of equivalent outer sensing sub-regions. The detector is electrically connected to the inner sensing region and the outer sensing region. When an object contacts a region of the inner sensing sub-regions or the outer sensing sub-regions, the detector generates a corresponding detected signal. The controller is used to receive the detected signal.

### BACKGROUND OF THE INVENTION

1. Field of the Invention

This present invention relates to a touch-sensing device, and more particularly, to a touch-sensing device for an electrical apparatus.

2. Description of the Prior Art

For the beautification and convenience in operation, a touch wheel has been increasingly employed on more and more electronic products. Take the media player iPod for an example, users can easily explore music, photos or films through one-hand operation on the touch wheel.

Please refer to FIG. 1. FIG. 1 is a schematic view of the touch wheel 1 of prior art. The touch wheel 1 has plural sensing sheets 10. When the finger of the user moves from a sensing sheet 10 to another one, the index in the display panel of the electronic product will perform a corresponding movement. Usually, the extent of the movement of the index is proportional to the quantity of the sensing sheets 10 subsequently contacted by the finger of the user. However, the touch wheel 1 of prior art is designed for the finger size of general users, thus restricting the application of the touch wheel 1. For example, if touch wheel 1 has a larger area, the finger of the user has to move for a longer distance so that the index in the display panel performs the corresponding movement. The drawback of the design inconveniences users.

Accordingly, a scope of the invention is to provide a touch-sensing device for an electrical apparatus.

### SUMMARY OF THE INVENTION

A scope of the invention is to provide a touch-sensing device and a sensing method for an electrical apparatus.

In an embodiment according to the invention, the touch-sensing device includes a sensing panel, a detector and a controller. The sensing panel includes an inner sensing region and an outer sensing region. The inner sensing region, disposed on the sensing panel, is substantially divided into a plurality of equivalent inner sensing sub-regions. The outer sensing region, disposed on the sensing panel and at the outer edge of the inner sensing region, is substantially divided into a plurality of equivalent outer sensing sub-regions.

The detector is electrically connected to the inner sensing region and the outer sensing region. When an object contacts a region of the inner sensing sub-regions or the outer sensing sub-regions, the detector generates a corresponding detected signal. The controller is for receiving the detected signal.

In another embodiment according to the invention, a sensing method for the electrical apparatus is provided. The electrical apparatus includes a sensing panel. The sensing panel includes an inner sensing region and an outer sensing region. The inner sensing region, disposed on the sensing panel, is substantially divided into a plurality of equivalent inner sensing sub-regions. The outer sensing region, disposed on the sensing panel and at the outer edge of the inner sensing region, is substantially divided into a plurality of equivalent outer sensing sub-regions.

In the method, a corresponding detected signal is first generated when an object contacts a region of the inner sensing sub-regions or the outer sensing sub-regions. Subsequently, the detected signal is received.

Compared to the prior art, the sensing panel of the touch-sensing device according to the invention includes the inner sensing region and the outer sensing region. Both the inner sensing region and the outer sensing region are divided into a plurality of equivalent sensing sub-regions. Thus, whether the finger of a user moves on the inner portion or the outer portion of the sensing panel, the touch-sensing device has similar sensitivity for the movement of the finger. Therefore, the design of the touch-sensing device according to the invention is not limited by the finger size of the user.

The advantage and spirit of the invention may be understood by the following recitations together with the appended drawings.

### BRIEF DESCRIPTION OF THE APPENDED DRAWINGS

FIG. 1 is a schematic view of the touch wheel of prior art.

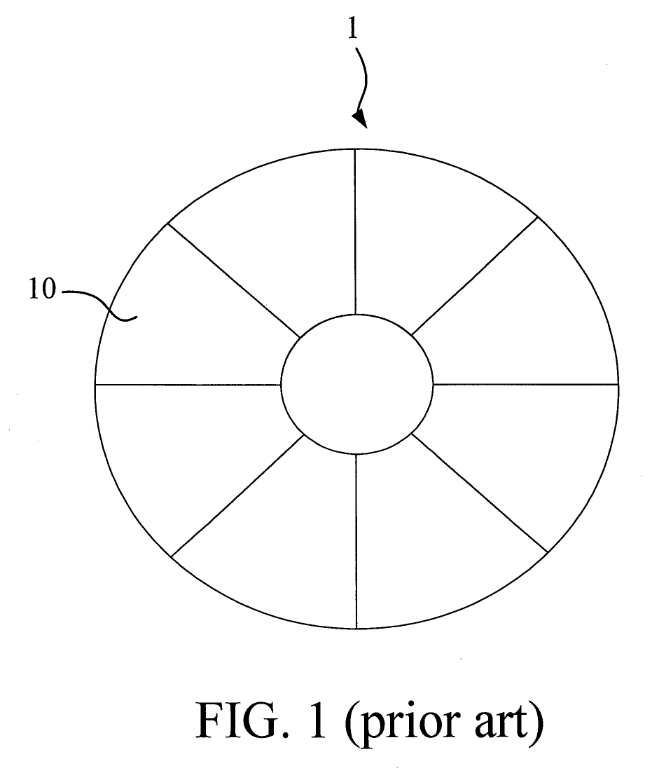

FIG. 2 is a schematic view of a touch-sensing device for an electrical apparatus according to an embodiment of the invention.

FIG. 3 is a flow chart of a sensing method for an electrical apparatus according to another embodiment of the invention.

### DETAILED DESCRIPTION OF THE INVENTION

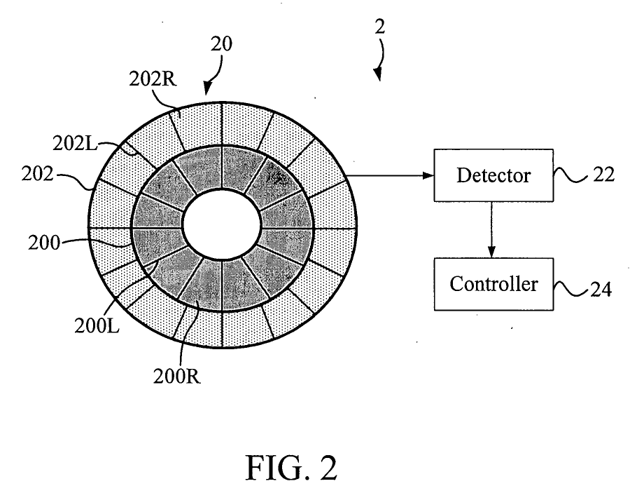

Please refer to FIG. 2. FIG. 2 is a schematic view of a touch-sensing device 2 for an electrical apparatus according to an embodiment of the invention. As shown in FIG. 2, the touch-sensing device 2 includes a sensing panel 20, a detector 22 and a controller 24. In practical application, the shape of the sensing panel 20 can be a circle or a regular polygon. In addition, the sensing panel 20 can include a plurality of capacitive sensors for sensing whether an object contacts the sensing panel 20.

In the embodiment, for example, the shape of the sensing panel 20 is a circle. As shown in FIG. 2, the sensing panel 20 includes an inner sensing region 200 and an outer sensing region 202. The inner sensing region 200 and the outer sensing region 202 can respectively form a ring. In practical application, the sensing panel 20 can include more sensing regions and is not limited to the inner sensing region 200 and the outer sensing region 202. The quantity of the sensing regions can be determined according to practical applications.

The central area of the sensing panel 20 is too small for sensing. The inner sensing region 200, disposed on the sensing panel 20, is substantially divided into a plurality of equivalent inner sensing sub-regions 200R. The outer sensing region 202, disposed on the sensing panel 20 and at the outer edge of the inner sensing region 200, is substantially divided into a plurality of equivalent outer sensing sub-regions 202R. Any two adjacent inner sensing sub-regions 200R are separated by an inner sideline 200L, and any two adjacent outer sensing sub-regions 202R are separated by an outer sideline 202L.

The detector 22 is electrically connected-to the inner sensing region 200 and the outer sensing region 202. When the object contacts a region of the inner sensing sub-regions 200R or the outer sensing sub-regions 202R, the detector 22 generates a corresponding detected signal. The controller 24 is for receiving the detected signal.

In practical application, when the object contacts the inner sensing region 200 and the outer sensing region 202 simultaneously, the detector 22 generates a first detected signal corresponding to the inner sensing region 200 and a second detected signal corresponding to the outer sensing region 202. The controller 24 selectively receives the first detected signal or the second detected signal according to the strength of the first detected signal and the second detected signal. For example, the controller 24 can receive the detected signal with stronger strength.

In the embodiment, when the object contacts a first inner sideline 200L and then moves toward a first direction within the inner sensing region 200 to contact a second inner sideline 200L, the detector 22 generates a first forward signal. When the object contacts the first inner sideline 200L and then moves toward a second direction within the inner sensing region 200 to contact the second inner sideline 200L, the detector 22 generates a first backward signal, wherein the second direction is opposite to the first direction.

In contrast, when the object contacts a first outer sideline 202L and then moves toward a first direction within the outer sensing region 202 to contact a second outer sideline 202L, the detector 22 generates a second forward signal. When the object contacts the first outer sideline 202L and then moves toward a second direction within the outer sensing region 202 to contact the second outer sideline 202L, the detector 22 generates a second backward signal, wherein the second direction is opposite to the first direction.

For example, when the finger of a user contacts the first inner sideline 200L and then moves toward a clockwise direction within the inner sensing region 200 to contact the second inner sideline 200L, the detector 22 generates the first forward signal. In practice, if the touch-sensing device 2 according to the invention is employed on an MP3 player, the first forward signal can make an index in the play list move from an item down to a next one. Alternatively, the first forward signal can also turn up the volume of the MP3 player.

In contrast, when the finger of the user contacts the first inner sideline 200L and then moves toward a counterclockwise direction within the inner sensing region 200 to contact the second inner sideline 200L, the detector 22 generates the first backward signal. Meanwhile, the first backward signal can make the index in the play list move from an item up to a next one. Alternatively, the first backward signal can turn down the volume of the MP3 player. Based on the same operational principle, the movement of the finger of the user within the outer sensing region 202 is not repeated therein.

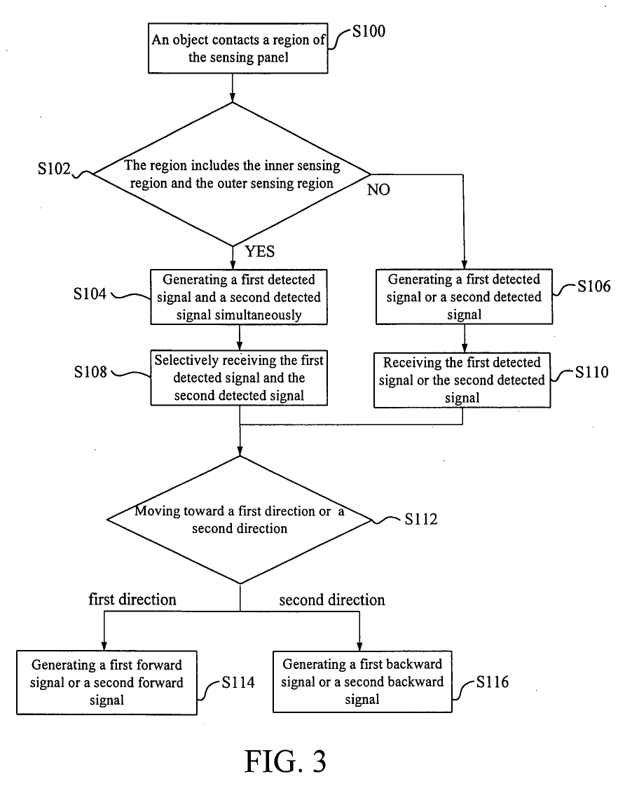

Please refer to FIG. 3. FIG. 3 is a flow chart of a sensing method for an electrical apparatus according to another embodiment of the invention. The electrical apparatus includes a sensing panel 20. The sensing panel 20 includes an inner sensing region 200 and an outer sensing region 202. The inner sensing region 200, disposed on the sensing panel 20, is substantially divided into a plurality of equivalent inner sensing sub-regions 200R. The outer sensing region 202, disposed on the sensing panel 20 and at the outer edge of the inner sensing region 200, is substantially divided into a plurality of equivalent outer sensing sub-regions 202R.

First, an object contacts a region of the sensing panel 20 in step S100. Next, whether the region includes both the inner sensing region 200 and the outer sensing region 202 is determined in step S102. If the region includes both the inner sensing region 200 and the outer sensing region 202, a first detected signal corresponding to the inner sensing region 200 and a second detected signal corresponding to the outer sensing region 202 are generated simultaneously in step S104. Then, according to the strength of the first detected signal and the second detected signal, the first detected signal or the second detected signal is selectively received in step S108. If the region includes the inner sensing region 200 or the outer sensing region 202, the first detected signal or the second detected signal is generated in step S106. Afterwards, the first detected signal or the second detected signal is received in step S110.

When the object moves in the inner sensing region 200 or the outer sensing region 202, whether the object moves toward a first direction or toward a second direction opposite to the first direction is judged in step S112. When the object moves toward the first direction, a first forward signal or a second forward signal is generated in step S114. When the object moves toward the second direction, a first backward signal or a second backward signal is generated in step S116.

Compared to the prior art, the sensing panel of the touch-sensing device according to the invention includes the inner sensing region and the outer sensing region. Both the inner sensing region and the outer sensing region are divided into a plurality of equivalent sensing sub-regions. Thus, no matter the finger of a user moves on the inner portion or the outer portion of the sensing panel, the touch-sensing device has similar sensitivity for the movement of the finger. Therefore, the design of the touch-sensing device according to the invention is not limited by the finger size of the user.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch-sensing device for an electrical apparatus, comprising:
a sensing panel, comprising:
an inner sensing region, disposed on the sensing panel, the inner sensing region being substantially divided into a plurality of equivalent inner sensing sub-regions; and
an outer sensing region, disposed on the sensing panel and at the outer edge of the inner sensing region, the outer sensing region being substantially divided into a plurality of equivalent outer sensing sub-regions;
a detector, electrically connected to the inner sensing region and the outer sensing region, when an object contacts a region of the inner sensing sub-regions or the outer sensing sub-regions, the detector generating a corresponding detected signal; and
a controller, for receiving the detected signal.

2. The touch-sensing device of claim 1, wherein any two adjacent inner sensing sub-regions are separated by an inner sideline, and any two adjacent outer sensing sub-regions are separated by an outer sideline.

3. The touch-sensing device of claim 2, wherein when the object contacts a first inner sideline and then moves toward a first direction within the inner sensing region to contact a second inner sideline, the detector generates a first forward signal; when the object contacts the first inner sideline and then moves toward a second direction within the inner sensing region to contact the second inner sideline, the detector generates a first backward signal, wherein the second direction is opposite to the first direction.

4. The touch-sensing device of claim 2, wherein when the object contacts a first outer sideline and then moves toward a first direction within the outer sensing region to contact a second outer sideline, the detector generates a second forward signal; when the object contacts the first outer sideline and then moves toward a second direction within the outer sensing region to contact the second outer sideline, the detector generates a second backward signal, wherein the second direction is opposite to the first direction.

5. The touch-sensing device of claim 1, wherein when the object contacts the inner sensing region and the outer sensing region simultaneously, the detector generates a first detected signal corresponding to the inner sensing region and a second detected signal corresponding to the outer sensing region, the controller selectively receives the first detected signal or the second detected signal according to the strength of the first detected signal and the second detected signal.

6. The touch-sensing device of claim 1, wherein the sensing panel comprises a plurality of capacitive sensors for sensing whether the object contacts the sensing panel.

7. The touch-sensing device of claim 1, wherein the shape of the sensing panel is a circle or a regular polygon.

8. A sensing method for an electrical apparatus, the electrical apparatus comprising a sensing panel, the sensing panel comprising an inner sensing region and an outer sensing region, the inner sensing region being disposed on the sensing panel and substantially divided into a plurality of equivalent inner sensing sub-regions, the outer sensing region being disposed on the sensing panel and at the outer edge of the inner sensing region, the outer sensing region being substantially divided into a plurality of equivalent outer sensing sub-regions, the method comprising the steps of
generating a corresponding detected signal when an object contacts a region of the inner sensing sub-regions or the outer sensing sub-regions; and
receiving the detected signal.

9. The method of claim 8, wherein any two adjacent inner sensing sub-regions are separated by an inner sideline, and any two adjacent outer sensing sub-regions are separated by an outer sideline.

10. The method of claim 9, further comprising the step of
generating a first forward signal when the object contacts a first inner sideline and then moves toward a first direction within the inner sensing region to contact a second inner sideline; and
generating a first backward signal when the object contacts the first inner sideline and then moves toward a second direction within the inner sensing region to contact the second inner sideline, wherein the second direction is opposite to the first direction.

11. The method of claim 9, further comprising the step of:
generating a second forward signal when the object contacts a first outer sideline and then moves toward a first direction within the outer sensing region to contact a second outer sideline; and
generating a second backward signal when the object contacts the first outer sideline and then moves toward a second direction within the outer sensing region to contact the second outer sideline, wherein the second direction is opposite to the first direction.

12. The method of claim 8, further comprising the step of
generating a first detected signal corresponding to the inner sensing region and a second detected signal corresponding to the outer sensing region when the object contacts the inner sensing region and the outer sensing region simultaneously; and
selectively receiving the first detected signal or the second detected signal according to the strength of the first detected signal and the second detected signal.

13. The method of claim 8, wherein the sensing panel comprises a plurality of capacitive sensors for sensing whether the object contacts the sensing panel.

14. The method of claim 8, wherein the shape of the sensing panel is a circle or a regular polygon.
